(19) United States
(12) Patent Application Publication
(10) Pub. No.: US 2007/0282971 A1
(43) Pub. Date: Dec. 6, 2007

(54) System and method for secondary mode facsimile transmission notification

(75) Inventors: Mohammad Suleiman, Trabuco Canyon, CA (US); Fabio Gava, Ladera Ranch, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/444,599

(22) Filed: Jun. 1, 2006

(51) Int. Cl. G06F 15/16

(52) U.S. Cl. 709/217

(57) ABSTRACT

A system and method for the automatic secondary mode facsimile transmission notification of a facsimile recipient or facsimile sender. The sender of a facsimile transmission selects a designated recipient and, when required, selects primary destination data. The sender then selects a secondary mode notification address, associated with the sender, the recipient, or both, whereby a facsimile status message is transmitted to the notification address. A facsimile operation is then initiated on a sending document processing device, whereby facsimile data is generated and transmitted to a receiving document processing device. The sending document processing device then generates status data representative of the status of the facsimile transmission, e.g., duration, success, failure, time, date, etc. This status data is incorporated in a predetermined message format, e.g., electronic mail, SMS message, text message, pager message, and transmitted to the designated notification address.

### BACKGROUND OF THE INVENTION

This invention is directed to a system and method for secondary mode facsimile transmission notification. More particularly, this invention is directed to a system and method for notifying at least one of a sender and a recipient of the transmission status of a facsimile.

Generally, a user of a facsimile device will scan or otherwise transmit the document to be sent via facsimile to the facsimile device. The user or sender will then input the required information in order for the facsimile to be transmitted to the intended recipient or recipients. After the required information is entered, the facsimile device will then commence the process for transmitting the facsimile. Typically, the sender will wait for the facsimile device to complete the transmission process to ensure that the facsimile was sent to the recipient. Therefore, if an error occurs in the transmission of the facsimile, such as the facsimile device was not able to establish a connection with the recipient's facsimile device, the sender can attempt to transmit the facsimile again or to a different facsimile device associated with the recipient. The sender must then wait for the completion of this facsimile transmission. If the sender must attempt multiple times to send the same facsimile, the user spends much valuable time waiting for a successful completion.

Further, the sender will generally inform the intended recipient or recipients of the incoming facsimile in order for the recipient to watch for the facsimile and retrieve it from the recipient's facsimile device, particularly if the facsimile contains sensitive or confidential information. The sender will typically inform the recipient via either a telephone call or an electronic mail to the recipient. The sender must locate the recipient's telephone number or electronic mail address, and then transmit the notification. This notification further requires valuable time by the sender, particularly if the sender must make repeated attempts to contact the recipient or the facsimile is being transmitted to multiple recipients. As such, there is a need for an automatic notification to the sender as to the status of the facsimile transmission and to the intended recipient or recipients of an incoming facsimile.

The subject application overcomes the above-noted problems and provides a system and method for secondary mode facsimile transmission notification.

### SUMMARY OF THE INVENTION

In accordance with the subject application, there is provided a system and method for secondary mode facsimile transmission notification.

Still further, in accordance with the subject application, there is provided a system and method for notifying at least one of a sender and a recipient of the transmission status of a facsimile.

Still further, in accordance with the subject application, there is provided a system and method for an automatic notification to the sender as to the status of the facsimile transmission and to the intended recipient or recipients of an incoming facsimile.

Still further, in accordance with the subject application, there is provided a system for secondary mode facsimile transmission notification. The system includes means adapted for receiving data representative of an associated facsimile transmission, facsimile message destination data representative of a destination associated with the associated facsimile, and notification address data representative of a secondary communication mode address corresponding to the destination data. The system also includes status means adapted for generating a status message corresponding to the associated facsimile transmission and means adapted for commencing a transmission of the status message to the secondary communication mode address via a secondary, non-facsimile communication system.

Still further, in accordance with the subject application, there is provided a method for secondary mode facsimile transmission notification. The method includes receiving data representative of an associated facsimile transmission, facsimile message destination data representative of a destination associated with the associated facsimile, and notification address data representative of a secondary communication mode address corresponding to the destination data. The method then generates a status message corresponding to the associated facsimile transmission and commences a transmission of the status message to the secondary communication mode address via a secondary, non-facsimile communication system.

Preferably, the destination data includes a facsimile number of an associated recipient. Also, preferably, the status message is sent to at least one of the sender and the recipient and is sent via at least one of electronic mail, verbal phone message, pager message, SMS message, instant message, and text message.

In one embodiment, the system and method include the ability to prompt an associated user for the notification address data.

In another embodiment, the notification address data is retrieved from an associated data storage.

Another embodiment of the system and method further include receiving selection data representative of at least one selected secondary communication mode.

In yet another embodiment, the system and method include the ability to generate the status message inclusive of information of at least one of successful transmission, unsuccessful transmission, time of transmission, date of transmission, summary information relative to content of the associated facsimile transmission, duration of transmission, and information relative to partial transmission.

Still other advantages, aspects and features of the subject application will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject application is described with reference to certain figures, including:

FIG. 1 which is an overall system diagram for system for a system for secondary mode facsimile transmission notification according to the subject application;

FIG. 2 is a block diagram illustrating controller hardware for use in the system for secondary mode facsimile transmission notification to a sender of a facsimile according to the subject application;

FIG. 3 is a functional block diagram illustrating the controller for use in the system for secondary mode facsimile transmission notification to a sender of a facsimile according to the subject application;

FIG. 4 is a flowchart illustrating the method for secondary mode facsimile transmission notification to a sender of a facsimile according to the subject application; and

FIG. 5 is a flowchart illustrating the method for secondary mode facsimile transmission notification to a recipient of a facsimile according to the subject application.

### DETAILED DESCRIPTION OF THE PREFERRED EMBODIMENT

The subject application is directed to a system and method for secondary mode facsimile transmission notification. In particular, the subject application is directed to a system and method for notifying at least one of a sender and a recipient of the transmission status of a facsimile. More particularly, the subject application is directed to a system and method for an automatic notification to the sender as to the status of the facsimile transmission and to the intended recipient or recipients of an incoming facsimile.

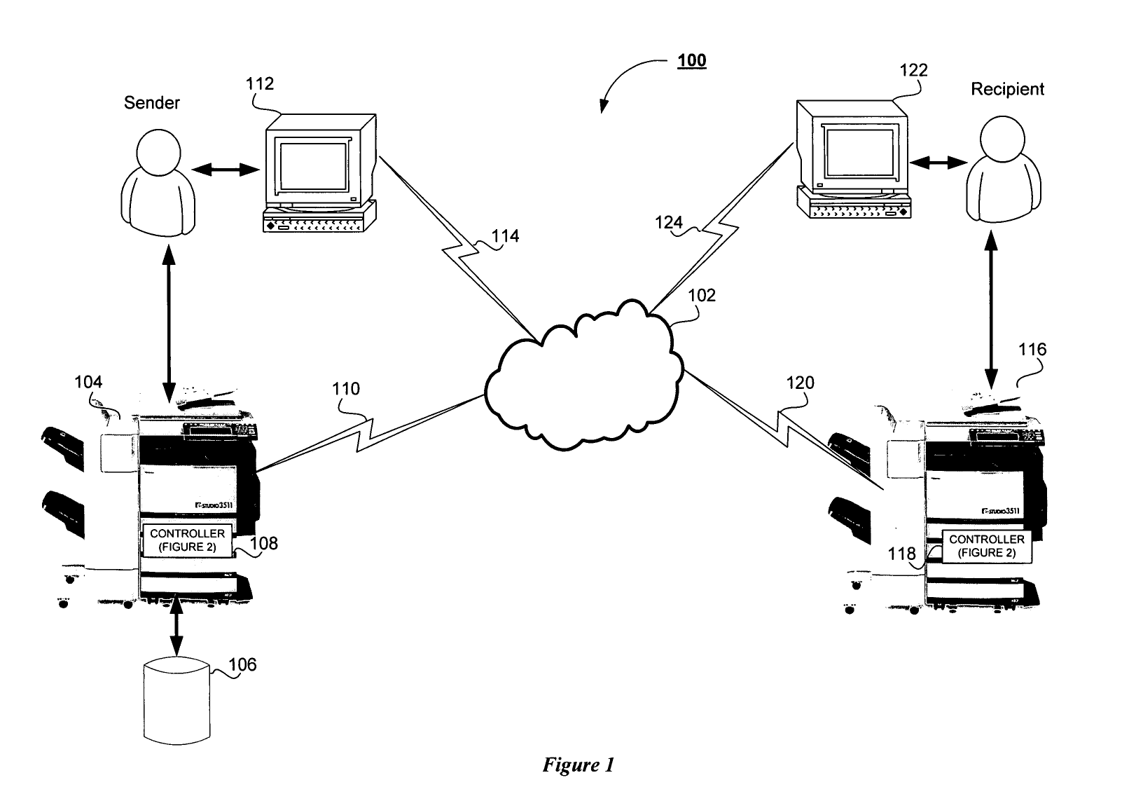

Turning first to FIG. 1, there is shown a block diagram illustrating a system 100 in accordance with the subject application. As illustrated in FIG. 1, the system 100 includes a distributed network environment, represented as a computer network 102. It will be appreciated by those skilled in the art that the computer network 102 is any distributed communications network known in the art capable of allowing two or more electronic devices to exchange communications and data. The computer network 102 is capable of being implemented, for example and without limitation, on the Internet, a wide area network, a local area network, a personal area network, or any suitable combination thereof. In accordance with the preferred embodiment of the subject application, the computer network 102 is comprised of physical layers and transport layers, incorporated within a plurality of conventional data transport mechanisms, including, for example and without limitation, Ethernet, Token-Ring, 802.11(x), or other wired or wireless data communications means.

According to the subject application, the system 100 further includes a sender, i.e., a sending user, a sending document processing device 104, a data store 106 communicatively coupled to the document processing device 104, and a sending user client device 112. It will be appreciated by those skilled in the art the document processing device 104 is advantageously represented in FIG. 1 as a multifunction peripheral device, suitably adapted to provide a variety of document processing services, such as, for example and without limitation, electronic mail, scanning, copying, facsimile, document management, printing, and the like. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like.

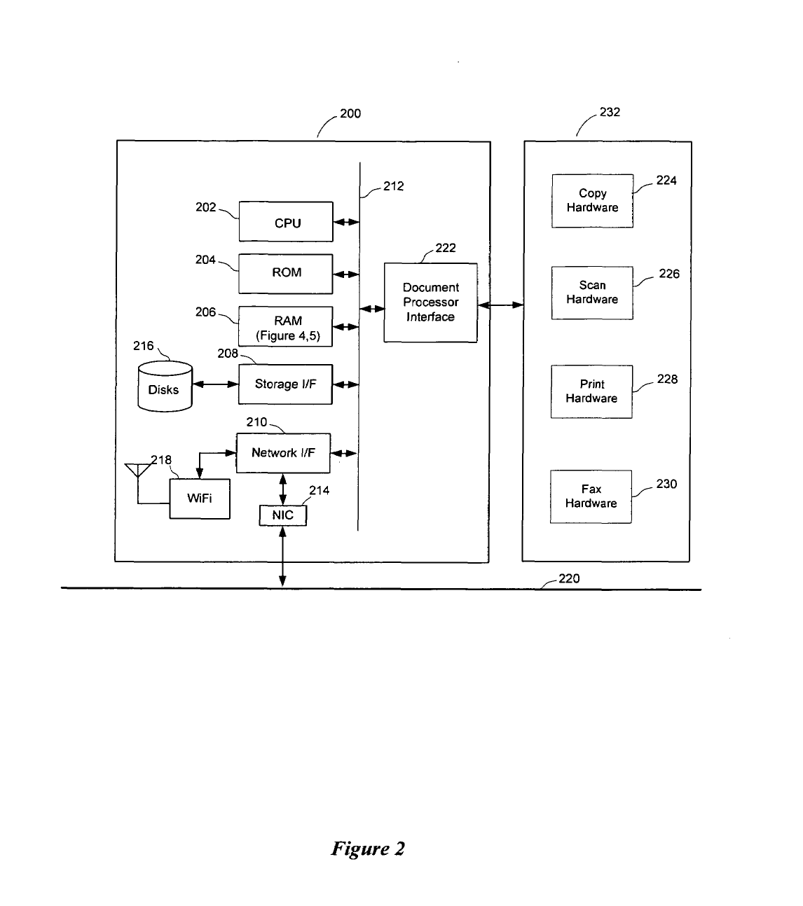

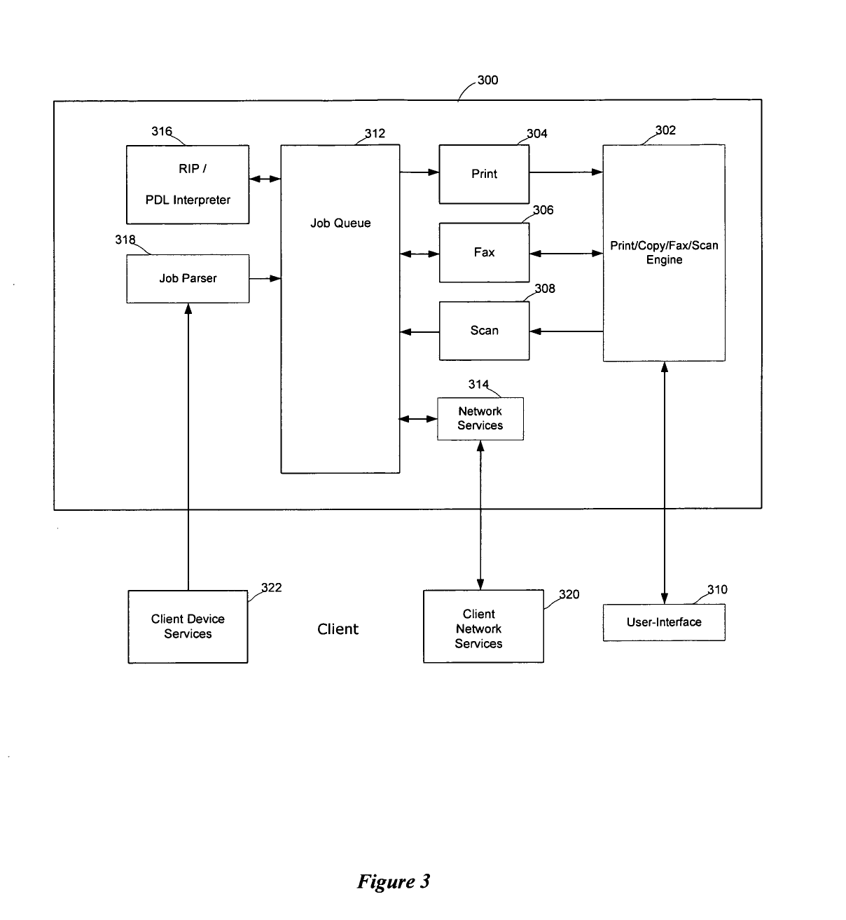

In the preferred embodiment of the subject application, the document processing device 104 further includes an associated user-interface, such as a touch-screen interface, LCD display, or the like, via which an associated user is able to interact directly with the document processing device 104. In accordance with the subject application, the document processing device 104 further incorporates a controller 108, suitably adapted to facilitate the operations of the first document processing device 104, as will be understood by those skilled in the art. Preferably, the controller 108 is embodied as hardware, software, or any suitable combination thereof, configured to control the operations of the associated document processing device 104, control the display of images via the user-interface, and the like. The functioning of the controller 108 will better be understood in conjunction with the block diagrams illustrated in FIGS. 2 and 3, explained in greater detail below.

The document processing device 104 is in data communication with the computer network 102 via a suitable communication link 110. In accordance with the preferred embodiment of the subject application, a suitable communications link 110 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

Communicatively coupled to the sending document processing device 104 is an associated data storage device 106. Preferably, the data storage device 106 stores user data including, for example and without limitation, a facsimile telephone number, an electronic mail address, an Internet Protocol address, a portable telephone number, and other user associated data. The skilled artisan will appreciate that other user data is equally capable of being stored in the data storage device 106 with respect to user addresses and contact information. As will be understood by those skilled in the art, the data storage device 106 is any mass storage device known in the art, including, for example and without limitation, magnetic disk storage, optical storage, non-volatile memory, and the like. In one embodiment, the data storage device 106 is capable of being communicatively coupled to the computer network 102, whereby the sending document processing device 104 retrieves data stored thereon via the communications link 108. In accordance with one aspect of the subject application, the data storage device 106 is a hard disk drive operatively coupled to the sending document processing device 104.

It will be appreciated by those skilled in the art that the sending user client device 112 is depicted in FIG. 1 as a computer workstation for illustration purposes only. As the skilled artisan will understand, the sending user client device 112 shown in FIG. 1 is representative of any personal computing device known in the art, including, for example and without limitation, a personal computer, a laptop computer, a personal data assistant, a proprietary networked portable electronic device, a web-enabled cellular telephone, a smart phone, or other web-enabled electronic device suitably capable of electronic notifications. Communication between the sending user client device 112 and the computer network 102 is advantageously accomplished via the communications link 114. The communications link 114 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In the preferred embodiment, the sending user client device 112 is suitably adapted to receive a variety of electronic messaging formats, as are known in the art.

As illustrated in FIG. 1, the system 100 also includes a recipient, i.e., a receiving user, a receiving document processing device 116 and a receiving user client device 122. It will be understood by the skilled artisan that the document processing device 116, as depicted in FIG. 1, is a multifunction peripheral device, suitably adapted to provide document processing services to users, including, for example and without limitation, printing, facsimile, copying, scanning, document management, electronic mail, and the like. A suitable commercially available document processing device includes, for example and without limitation, the Toshiba e-Studio Series Controller. In accordance with one aspect of the subject application, the document processing device 116 is suitably equipped to receive a plurality of portable storage media, including without limitation, MMC, XD, USB drive, SD, Compact Flash, Firewire drive, Memory Stick, and the like.

The receiving document processing device 116 further incorporates a controller 118, suitably configured to control operations of the document processing device 116, image display on the user-interface, receipt of user instructions, and the like. The skilled artisan will appreciate that the controller 118 is any hardware, software, or suitable combination thereof capable of facilitating the control of the document processing device 118 in accordance with the subject application. The functioning of the controller 118, similar to that of the controller 108, will better be understood in conjunction with the block diagrams illustrated in FIGS. 2 and 3, explained in greater detail below.

Similar to the sending document processing device 104, the receiving document processing device 116, in accordance with the subject application, includes an associated user-interface, such as a touch-screen interface, LCD display, or the like, via which an associated receiving user is able to interact directly with the document processing device 116. The receiving document processing device 116 is in data communication with the computer network 102 via a suitable communication link 120. In accordance with the subject application, a suitable communications link 120 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

The skilled artisan will understand and appreciate that the depiction of the receiving user client device 122, of FIG. 1, as a computer workstation is for illustration purposes only. It will be apparent to those skilled in the art that any personal computing device, known in the art, adapted for receiving electronic messages is capable of being implemented as the receiving user client device 122, including, for example and without limitation, a personal data assistant, a laptop computer, a personal computer, a smart phone, a web-enabled cellular telephone, a proprietary networked portable electronic device, or other web-enabled electronic device suitably capable of electronic notifications. The receiving user client device 122 is in data communication with the computer network 102 via a suitable communications link 124. Preferably, the communications link 124 is any suitable channel of data communications known in the art including, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Turning now to FIG. 2, illustrated is a representative architecture of a suitable controller 200 on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the sender, associated with the sending document processing device 104, initiates a facsimile operation via the associated user-interface. As will be appreciated by those skilled in the art, a facsimile operation suitably involves the scanning of a paper document into electronic format resulting in electronic document data, whereupon the electronic document data is transmitted via the public-switched telephone network to the receiving document processing device 116. The controller 118 associated with the receiving document processing device 116 then converts the received electronic document data into a suitable output format, thereafter outputting the document in hardcopy form for a recipient. While the public-switched telephone network is capable of being used in accordance with the subject application, the skilled artisan will appreciate that facsimile transmissions, as set forth hereinafter, are equally capable of being implemented via the computer network 102. The skilled artisan will further understand that the sending document processing device 104 is also capable of using a facsimile operation to transmit a document in electronic form to a receiving document processing device 116. For example, a sender provides a portable storage media to the sending document processing device 104 and selects an electronic document stored thereon. The electronic document is then facsimile transmitted in accordance with the methodology described hereinafter.

When a facsimile operation is selected by the sender, via the associated user-interface, the controller 108 associated with the sending document processing device 104 first determines whether the designated recipient is a new recipient. When the recipient is a new recipient, the controller 108 associated with the sending document processing device 104 prompts the sender to input primary destination data associated with the new recipient. As will be appreciated by those skilled in the art, suitable primary destination data includes, for example and without limitation, a telephone number associated with a receiving document processing device 116, an IP address associated with a receiving document processing device 116, an electronic mail account associated with a receiving document processing device 116, or the like. The skilled artisan will understand that the primary address data associated with the new recipient corresponds to the principle address designating the receiving document processing device 116 with which the recipient is associated. In the preferred embodiment, this new primary destination data is then stored in the associated data storage device 106.

When the designated recipient is not a new recipient, the controller 108 associated with the sending document processing device 104 prompts the sender to select a recipient from a list of recipients stored in the associated data storage device 106. The controller 108 associated with the sending document processing device 104 then retrieves the primary destination data associated with the designated recipient from the associated data storage device 106. A determination is then made by the controller 108 associated with the sending document processing device 104 whether secondary notification is required, i.e., whether the sender, the recipient, or both, desire notification as to the status of the facsimile operation. When such notification is requested, the sender is prompted to input the notification address for the sender, the recipient, or both, to which the status of the facsimile operation is to be sent. Thus, when the sender desires to receive notification of the status of given facsimile operation, the sender inputs a secondary address to which the status of the operation is to be forwarded. For example, the secondary address is capable of including, for example and without limitation, electronic mail, verbal phone message, pager message, SMS message, instant message, text message, and the like. It will be understood by those skilled in the art that the notification address is capable of being retrieved from a variety of locations, including for example and without limitation, the associated data storage 106, a network storage, and the like. As the skilled artisan will appreciate, when the sender inputs an electronic mail address, the sender is able to monitor the status of the facsimile operation via the sending user client device 112, a portable handheld device, or the like.

Once the sending document processing device 104 has received the primary destination address for the facsimile operation, as well as any secondary notification addresses, the device 104 generates facsimile data. It will be understood by those skilled in the art the generation of the facsimile data is capable of including, for example and without limitation, scanning a paper document into electronic data, retrieving an electronic document from a portable storage medium, retrieving an electronic document from an electronic mail attachment, retrieving an electronic document from a network storage location, or the like. The generated facsimile data is then transmitted to the primary destination address, e.g., the address associated with the receiving document processing device 116. When secondary notification has been previously requested by the sender, the controller 108 associated with the sending document processing device 104 then generates a facsimile status message. Preferably the status message includes, for example and without limitation, data representing a successful transmission, an unsuccessful transmission, a time of transmission, a date of transmission, summary information relative to the content of the associated facsimile transmission, duration of transmission, information relative to partial transmission, or the like.

The generated status message is then transmitted to the designated secondary notification address by the controller 108 associated with the sending document processing device 104. Thus, when notification has been set for the recipient, the controller 108 associated with the sending document processing device 104 transmits the status message to the recipient at the notification address set by the sender. For example, when the notification address corresponds to a telephone number, an automated telephone call is placed to the telephone number, thereby notifying the recipient of the transmission of the facsimile document. When the notification address corresponds to an electronic mail address, a text message address, or the like, the generated status message is sent to the recipient at the receiving user client device 122, an associated portable handheld device, or the like.

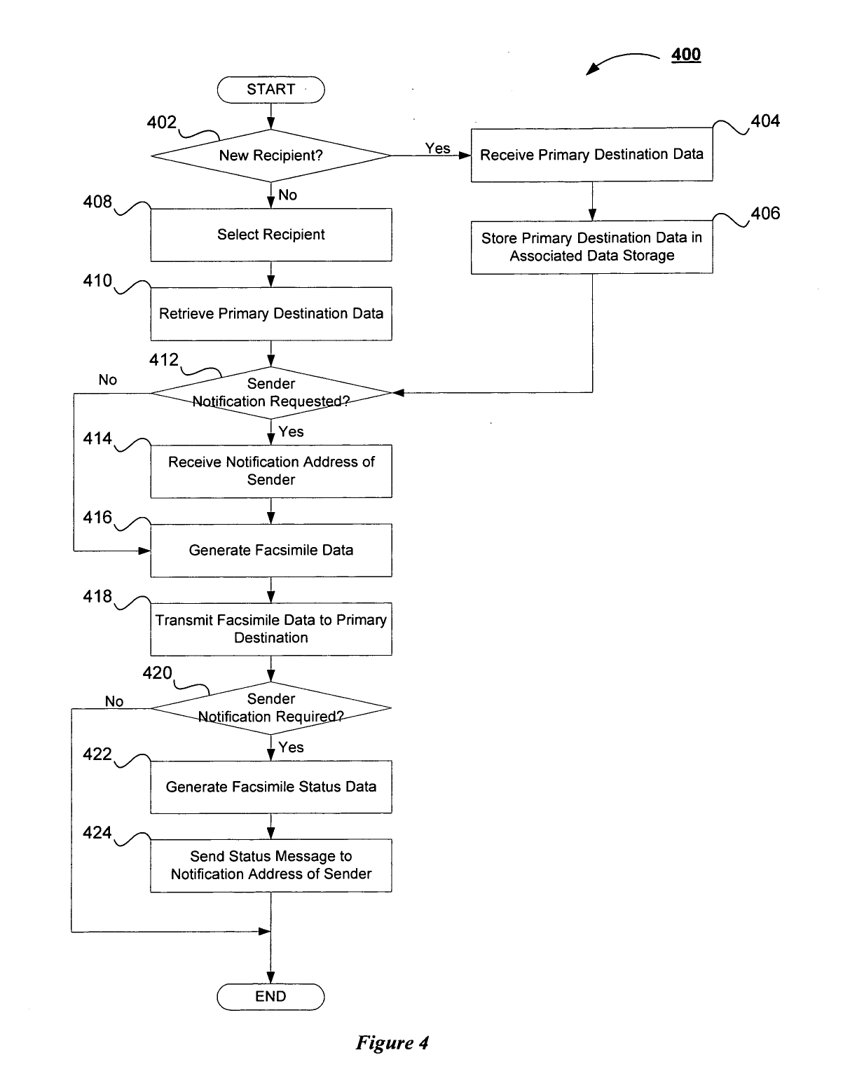

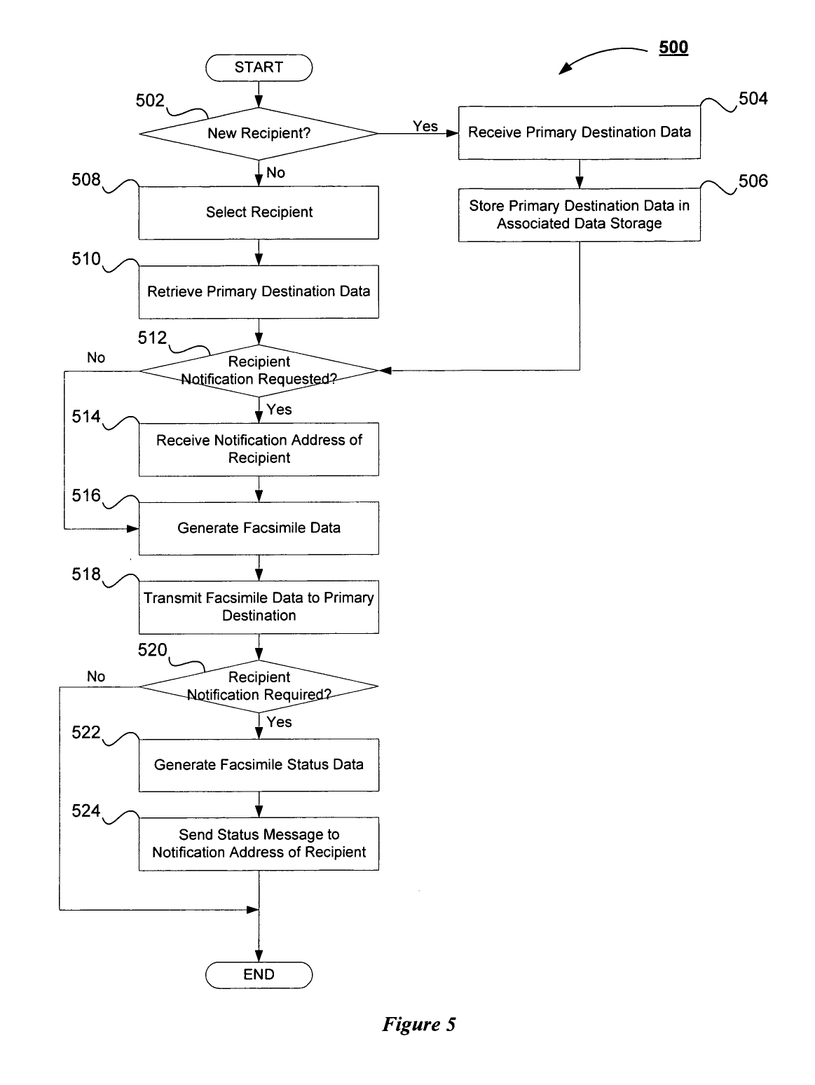

The skilled artisan will appreciate that additional embodiments are contemplated in accordance with the system 100 described above in FIGS. 1, 2, and 3, and in conjunction with the methodologies illustrated in FIG. 4 and FIG. 5. Turning now to FIG. 4, there is shown a flowchart 400 depicting a method for secondary mode facsimile transmission notification to a sender of a facsimile in accordance with the subject application. As illustrated in FIG. 4, when a sender desires to transmit a facsimile to a recipient, a determination is first made by the controller 108 associated with the sending document processing device 104 at step 402 whether the recipient is a new recipient. A positive determination at step 402 prompts the sender to input the primary destination address data associated with the new recipient at step 404. It will be appreciated by those skilled in the art that the primary destination data designates the receiving document processing device 116 with which the new recipient is associated. Thus, the destination data includes, for example and without limitation, an IP address, an electronic mail address, a telephone number, and the like. In accordance with the preferred embodiment of the subject application, the input destination data associated with the new recipient is stored in the associated data storage device 106 at step 406. It will be appreciated by those skilled in the art that the storage of the new recipient primary destination data enables a sender to send additional facsimiles to the recipient, without requiring the sender to input the destination information for each facsimile transmission. Flow then progresses from step 406 to step 412, wherein a determination is made whether the sender desires to receive notification, i.e., status information, with respect to the facsimile transmission.

Returning to step 402, when the sender desires to send the facsimile to a known recipient, flow proceeds to step 408, whereupon the sending user is prompted to select a recipient from among the recipient information stored in the associated data storage device 106. It will be understood by those skilled in the art that the controller 108 associated with the sending document processing device 104 retrieves a listing of recipients having destination data stored thereon from the data storage device 106 via any suitable means known in the art. The controller 108 associated with the sending document processing device 104 then retrieves, based on the recipient selection of step 408, primary destination data from the associated data storage device 106 at step 410. A determination is then made at step 412 whether status notification to the sender is requested by the sender. When such notification is requested, flow proceeds to step 414, whereupon secondary notification address data associated with the sender is received by the controller 108 associated with the sending document processing device 104. It will be appreciated by those skilled in the art that suitable secondary notification address data includes, for example and without limitation, a text message address, an instant message address, a pager number, a voice telephone number, an SMS message address, an electronic mail address, or the like. It will be understood by those skilled in the art that the notification address is capable of being retrieved from a variety of locations, including for example and without limitation, the associated data storage 106, a network storage, and the like. Flow then proceeds to step 416, whereupon facsimile data representative of the document to be sent to the recipient is generated. The skilled artisan will appreciate that when no notification is desired by the sender at step 412, flow also proceeds to step 416 for the generation of facsimile data.

As will be apparent to those skilled in the art, the generation of facsimile data advantageously includes, but is not limited to, scanning a paper document so as to generate an electronic image of the document represented on the paper. The skilled artisan will further understand that the generation of facsimile data is not limited to scanning hardcopy documents, but is further capable of being generated from electronic document data stored in a portable storage medium, attached as an electronic mail message sent to the sending document processing device 104, stored on a network storage device accessible by the sending document processing device 104, or the like. Irrespective of the manner in which the facsimile data is generated at step 416, flow proceeds to step 418, whereupon the facsimile data is transmitted via the communications link 110 to the primary destination address, e.g., receiving document processing device 116. Those skilled in the art will understand that the facsimile transmission is capable of being sent via the public-switched telephone network, the Internet, or any other public or proprietary communications platform.

A determination is then made, at step 420, whether the sender has requested notification of the status of the facsimile transmission. When no such notification has been requested, as set forth above at step 412, the operation terminates. When the sender has requested, as established in step 412, that a notification be sent to the designated secondary notification address, the sending document processing device 104 then generates a facsimile status message at step 422. As discussed above, the status data incorporated into the facsimile status message includes, for example and without limitation, the time of transmission, the date of transmission, summary information relative to the content of the associated facsimile transmission, the duration of the transmission, the success of the transmission, information relative to the partial transmission of the facsimile data, the failure of the transmission, or the like. In the preferred embodiment, the facsimile status data is incorporated into a text message, an SMS message, a verbal phone message, a pager message, an instant message, an electronic mail message, or any other means of data communication known in the art.

The generated status message is then sent to the designated secondary transmission address, e.g., the sender, at step 424. Thus, for example and without limitation, when the sender has input an electronic mail address as the secondary notification address, the sending document processing device 104 transmits the status message to the sender at that designated address, whereupon the sender receives the message at, for example, the sending user client device 112. Having thus presented an example method of automatic sender notification in accordance with the subject application, discussion now turns to the automated notification of the recipient, as set forth in FIG. 5.

Referring now to FIG. 5, there is shown a flowchart 500 illustrating a method for secondary mode facsimile transmission notification to a recipient of a facsimile in accordance with the subject application. FIG. 5 illustrates a methodology implemented when the sender desires to notify an intended recipient of a facsimile transmission with respect to the status of the transmission. Operations in accordance with this method begin at step 502, whereupon a determination is made whether the intended recipient is a new recipient. When the recipient is a new recipient, flow proceeds to step 504, whereupon the sender inputs, via the user-interface associated with the sending document processing device 104, the primary destination data corresponding to the new recipient. Preferably, the data input includes recipient identification data, receiving document processing device 116 identifying information, an IP address, an electronic mail address, a telephone number, and the like. This primary destination data is then stored in the associated data storage device 106 at step 506. The skilled artisan will appreciate that storing the primary destination data associated with the new recipient enables the sender to request subsequent facsimile transmissions to the recipient without having to input the primary destination data for each transmission. Flow then proceeds to step 512, wherein a determination is made whether the sender desires to send notification, i.e., status information with respect to the facsimile transmission, to the intended recipient.

When it is determined at step 502 that the intended recipient is not a new recipient, flow proceeds to step 508, wherein the sender is prompted to select the intended recipient from a list of stored recipients present on the data storage device 106. Those skilled in the art will understand that the controller 108 associated with the sending document processing device 104 retrieves recipient data from the data storage device 106 and displays the retrieved data to the sender for selection via the associated user-interface. Once the sender has selected the designated recipient, the controller 108 associated with retrieves the primary destination data from the data storage device 106 associated with the recipient at step 510. A determination is then made at step 512 whether a notification with respect to the status of the facsimile transmission is to be sent to the designated recipient. When such notification is requested, flow proceeds to step 514, whereupon secondary notification address data associated with the designated recipient is received from the sender by the controller 108 associated with the sending document processing device 104. It will be appreciated by those skilled in the art that suitable secondary notification address data includes, for example and without limitation, a text message address, an instant message address, a pager number, a voice telephone number, an SMS message address, an electronic mail address, or the like. It will be understood by those skilled in the art that the notification address is capable of being retrieved from a variety of locations, including for example and without limitation, the associated data storage 106, a network storage, and the like.

The generation of facsimile data representing the document to be sent to the designated recipient is then performed at step 516. It will be understood by those skilled in the art that when the recipient is not set to receive a notification at step 512, flow also proceeds to generate facsimile data at step 516. It will be apparent to those skilled in the art, that the generation of facsimile data advantageously includes, but is not limited to, scanning a paper document so as to generate an electronic image of the document represented on the paper, generating facsimile data from an electronic document stored on a portable storage medium or stored on network storage, attached as an electronic mail message, or the like. Once the facsimile data has been generated at step 516, the data is transmitted, at step 518, to the primary destination address, e.g., the receiving document processing device 116. The skilled artisan will appreciate that the facsimile data is suitably transmitted via the communications link 110, which is capable of comprising, for example and without limitation, the public-switched telephone network, the Internet, a proprietary telephone network, or the like.

A determination is then made at step 520 whether the sender has requested that a notification of the status of the facsimile transmission be sent to the designated recipient. When no recipient notification was requested by the sender at step 512, the operation terminates. When the sender previously requested at step 512 that the recipient receive a notification message via a secondary communication mode, flow proceeds to step 522, wherein a facsimile status message, including facsimile status data, is generated. As will be appreciated by those skilled in the art, facsimile status data, such as the date of transmission, the time of transmission, summary information relative to the content of the associated facsimile transmission, the success of the transmission, the duration of the facsimile transmission, information relative to the partial transmission of facsimile data, the failure of the facsimile transmission, and the like is gathered by the controller 108 associated with the sending document processing device 104 and used to generate, at step 520, a facsimile status message. In accordance with one aspect of the subject application, the facsimile status data is incorporated into a text message, an SMS message, a verbal phone message, a pager message, an instant message, an electronic mail message, or any other means of data communication known in the art.

The generated status message is then transmitted to the designated recipient, via the secondary notification address, at step 524. For example, when the notification address input at step 514 indicated an SMS message, the status message, in SMS format, is transmitted from the sending document processing device 104 to the recipient's cellular telephone, smart phone, portable handheld device, or other device designated in accordance with the received notification address data.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A secondary mode facsimile transmission notification system comprising:
means adapted for receiving data representative of an associated facsimile transmission;
means adapted for receiving facsimile message destination data representative of a destination associated with the associated facsimile;
means adapted for receiving notification address data representative of a secondary communication mode address corresponding to the destination data;
status means adapted for generating a status message corresponding to the associated facsimile transmission; and
means adapted for commencing a transmission of the status message to the secondary communication mode address via a secondary, non-facsimile communication system.

2. The secondary mode facsimile transmission notification system of claim 1 wherein the destination data includes a facsimile number of an associated recipient, and wherein the secondary communication mode includes at least one of electronic mail, verbal phone message, pager message, SMS message, instant message, and text message.

3. The secondary mode facsimile transmission notification system of claim 2 further comprising means adapted for prompting an associated user for the notification address data.

4. The secondary mode facsimile transmission notification system of claim 2 further comprising means adapted for retrieving the notification address data from an associated data storage.

5. The secondary mode facsimile transmission notification system of claim 2 further comprising means adapted for receiving selection data representative of at least one selected secondary communication mode.

6. The secondary mode facsimile transmission notification system of claim 2 wherein the status means includes means adapted for generating the status message inclusive of information of at least one of successful transmission, unsuccessful transmission, time of transmission, date of transmission, summary information relative to content of the associated facsimile transmission, duration of transmission, and information relative to partial transmission.

7. The secondary mode facsimile transmission notification system of claim 2 wherein the status message is transmitted to at least one of a sender of the facsimile and a recipient of the facsimile.

8. A secondary mode facsimile transmission notification method comprising the steps of:
receiving data representative of an associated facsimile transmission;
receiving facsimile message destination data representative of a destination associated with the associated facsimile;
receiving notification address data representative of a secondary communication mode address corresponding to the destination data;
generating a status message corresponding to the associated facsimile transmission; and
commencing a transmission of the status message to the secondary communication mode address via a secondary, non-facsimile communication system.

9. The secondary mode facsimile transmission notification method of claim 8 wherein the destination data includes a facsimile number of an associated recipient, and wherein the secondary communication mode includes at least one of electronic mail, verbal phone message, pager message, SMS message, instant message, and text message.

10. The secondary mode facsimile transmission notification method of claim 9 further comprising the step of prompting an associated user for the notification address data.

11. The secondary mode facsimile transmission notification method of claim 9 further comprising the step of retrieving the notification address data from an associated data storage.

12. The secondary mode facsimile transmission notification method of claim 9 further comprising the step of receiving selection data representative of at least one selected secondary communication mode.

13. The secondary mode facsimile transmission notification method of claim 9 wherein the step of generating a status message includes generating the status message inclusive of information of at least one of successful transmission, unsuccessful transmission, time of transmission, date of transmission, summary information relative to content of the associated facsimile transmission, duration of transmission, and information relative to partial transmission.

14. The secondary mode transmission facsimile transmission notification method of claim 9 wherein the status message is transmitted to at least one of a sender of the facsimile and a recipient of the facsimile.

15. A computer-implemented method for secondary mode facsimile transmission notification comprising the steps of:
receiving data representative of an associated facsimile transmission;
receiving facsimile message destination data representative of a destination associated with the associated facsimile;
receiving notification address data representative of a secondary communication mode address corresponding to the destination data;
generating a status message corresponding to the associated facsimile transmission; and
commencing a transmission of the status message to the secondary communication mode address via a secondary, non-facsimile communication system.

16. The computer-implemented method for secondary mode facsimile transmission notification of claim 15 wherein the destination data includes a facsimile number of an associated recipient, and wherein the secondary communication mode includes at least one of electronic mail, verbal phone message, pager message, SMS message, instant message, and text message.

17. The computer-implemented method for secondary mode facsimile transmission notification of claim 16 further comprising the step of prompting an associated user for the notification address data.

18. The computer-implemented method for secondary mode facsimile transmission notification of claim 16 further comprising the step of retrieving the notification address data from an associated data storage.

19. The computer-implemented method for secondary mode facsimile transmission notification of claim 16 further comprising the step of receiving selection data representative of at least one selected secondary communication mode.

20. The computer-implemented method for secondary mode facsimile transmission notification of claim 16 wherein the step of generating a status message includes generating the status message inclusive of information of at least one of successful transmission, unsuccessful transmission, time of transmission, date of transmission, summary information relative to content of the associated facsimile transmission, duration of transmission, and information relative to partial transmission.
